(19) United States
(12) Patent Application Publication
(10) Pub. No.: US 2026/0167043 A1
(43) Pub. Date: Jun. 18, 2026

(54) CHARGING CONTROL SYSTEM AND CHARGING PILE

(71) Applicant: HON HAI PRECISION INDUSTRY CO., LTD., New Taipei (TW)

(72) Inventor: MIN-CHUN JHENG, New Taipei (TW)

(21) Appl. No.: 19/318,754

(22) Filed: Sep. 4, 2025

(30) Foreign Application Priority Data
Dec. 18, 2024 (CN) 202423131837.8

(51) Int. Cl. B60L 53/62; B60L 53/31; H02J 7/00

(52) U.S. Cl. CPC B60L 53/62; B60L 53/31; H02J 7/663; H02J 7/80; B60L 2250/16

(57) ABSTRACT

A charging control system and a charging pile, including a first power switch, a second power switch, a first output interface for connecting to an electric vehicle, a second output interface for connecting to an electrical device, a detection module, and a control module. Input ends of the first and the second power switches are both connected to an external power supply, an output end of the first power switch is connected to the first output interface, an output end of the second power supply switch is connected to the second output interface. The detection module detects input and output parameters of the first and the second power switches, the control module receives detection data of the detection module and controls switching states of the first and the second power switches to control output status of the first and the second output interfaces.

### CROSS-REFERENCE TO RELATED APPLICATIONS

This application claims priority to China Patent Application No. 202423131837.8 filed on Dec. 18, 2024, in China National Intellectual Property Administration, the contents of which are incorporated by reference herein.

### FIELD

The subject matter herein generally relates to charging technology field, and more particularly to a charging control system and a charging pile.

### BACKGROUND

Charging piles are devices that replenish electric energy for electric vehicles. Currently, the charging piles on the market are limited to charging one or more electric vehicles at the same time, with a single function and cannot be fully utilized.

### BRIEF DESCRIPTION OF THE DRAWINGS

Implementations of the present disclosure will now be described, by way of embodiments, with reference to the attached figures.

FIG. 1 is a schematic diagram of a connection between a charging pile, an electric vehicle, and electrical device provided in an embodiment of the present application.

FIG. 2 is a schematic diagram of the charging pile provided in an embodiment of the present application.

FIG. 3 is a structural schematic diagram of a charging control system provided in an embodiment of the present application.

FIG. 4 is a circuit diagram of a test module in FIG. 3.

FIG. 5 is a circuit diagram of a ground protection detection circuit in FIG. 3.

FIG. 6 is a circuit diagram of the leakage detection circuit in FIG. 3.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

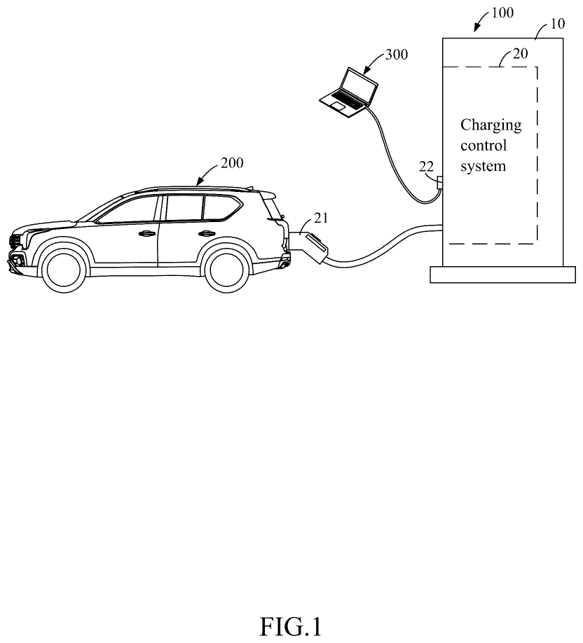

Referring to FIG. 1, which shows a schematic diagram of a charging pile 100 connected to an electric vehicle 200 and an electrical device 300 provided in an embodiment of the present application. As shown in FIG. 1, the charging pile 100 includes a housing 10 and a charging control system 20 mounted in the housing 10. The charging pile 100 can simultaneously provide power to the electric vehicle 200 and the electrical device 300 through the charging control system 20, or it can provide power to the electric vehicle 200 or the electric device 300 separately through the charging control system 20.

The electric vehicle 200 can be an electric car, an electric motorcycle, or other electrically powered vehicle. The electrical device 300 is a different type of device from the electric vehicle 200. The electrical device 300 includes an electronic terminal device, which can be, for example, a computer, a game console, an electrical appliance, an electric scooter, or other consumer electronics products, or lighting equipment, or smart city equipment.

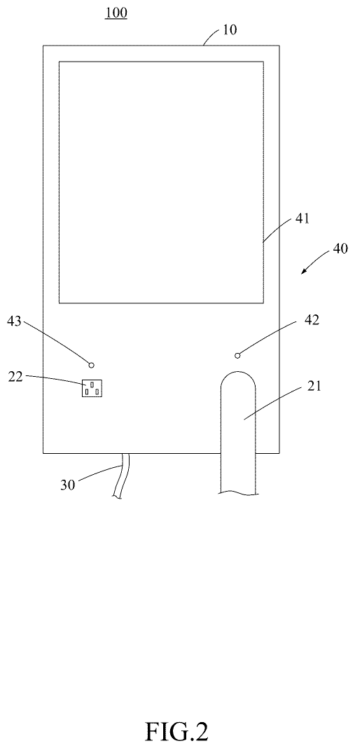

Referring to FIG. 2, the charging control system 20 can receive power from an external power source, such as a power grid, via a cable 30. The charging control system 20 includes a first output interface 21 and a second output interface 22, both of which are exposed on an outer surface of the housing 10. The first output interface 21 is compatible with the electric vehicle 200 and can be used to electrically connect to the electric vehicle 200 to supply power to the electric vehicle 200. The second output interface 22 is compatible with the electrical device 300 and can be used to electrically connect to the electrical device 300 to supply power to the electrical device 300.

The first output interface 21 is a charging plug that complies with the corresponding electric vehicle charging interface standard (such as GB/T 20234, J1772, NACS, CCS, or CHAdeMO). The specific configuration can be selected based on actual needs. The first output interface 21 can be inserted into a socket of the corresponding electric vehicle 200 to form an electrical connection with the electric vehicle 200.

The second output interface 22 is a socket that complies with a corresponding electrical device interface standard (e.g., GB/T 1003-2016, NEMA, NMX-J-163-ANCE, CSA C22.2 No. 42, or JIS C 8303). The specific socket can be selected based on actual circumstances. A plug of a compatible electrical device 300 or a power adapter plug of the electrical device 300 can be inserted into the second output interface 22 to establish an electrical connection with the electrical device 300.

The first output interface 21 includes a power terminal 211 (for ease of distinction, it can be called a first power terminal) and a signal terminal 212. The charging control system 20 can output power to the electric vehicle 200 through the first power terminal 211 of the first output interface 21, and can communicate with the electric vehicle 200 through the signal terminal 212 of the first output interface 21.

For example, the first power terminal 211 of the first output interface 21 may include a live wire terminal, a neutral wire terminal, and a ground wire terminal. The live wire terminal is used to connect to a live wire L of an external power supply, the neutral wire terminal is used to connect to a neutral wire N of the external power supply, and the ground wire terminal is used to connect to a ground wire (also known as the protective earthing, PE) of the external power supply. Normally, the neutral wire N of the external power supply is connected to the ground wire PE.

The signal terminal 212 of the first output interface 21 may include a charging confirm (CC) terminal and a control pilot (CP) terminal. The charging control system 20 and the electric vehicle 200 can confirm the connection status between the first output interface 21 and the electric vehicle 200 based on the electrical signal from the CC terminal. The charging control system 20 and the electric vehicle 200 can monitor the charging process based on the electrical signal of the CP terminal. During this process, the charging control system 20 can generate a PWM signal and transmit it through the CP terminal. The PWM signal serves as available output current information, and the duty cycle of the PWM signal indicates the available output current value of the first output interface 21. The available output current value of the first output interface 21 is the maximum output current value supported by the first output interface 21, the maximum output current value can be equal to a rated output current value of the first output interface 21 or less than the rated output current value of the first output interface 21. Furthermore, the vehicle control unit of the electric vehicle 200 can detect the PWM signal of the CP terminal and determine the charging current of the electric vehicle 200 based on the available output current value of the first output interface 21 and the state of the electric vehicle 200. The on-board charger (OBC) inside the electric vehicle 200 then controls the actual charging current of the electric vehicle 200 according to the charging current determined by the vehicle control unit. The actual charging current of the electric vehicle 200 is derived from the actual output current of the first output interface 21. Therefore, the actual output current of the first output interface 21 changes synchronously with the actual charging current of the electric vehicle 200.

For another example, the second output interface 22 may include a power terminal 221 (for ease of distinction, referred to as a second power terminal 221). The second power terminal 221 of the second output interface 22 may refer to the description of the first output interface 21 and will not be repeated here.

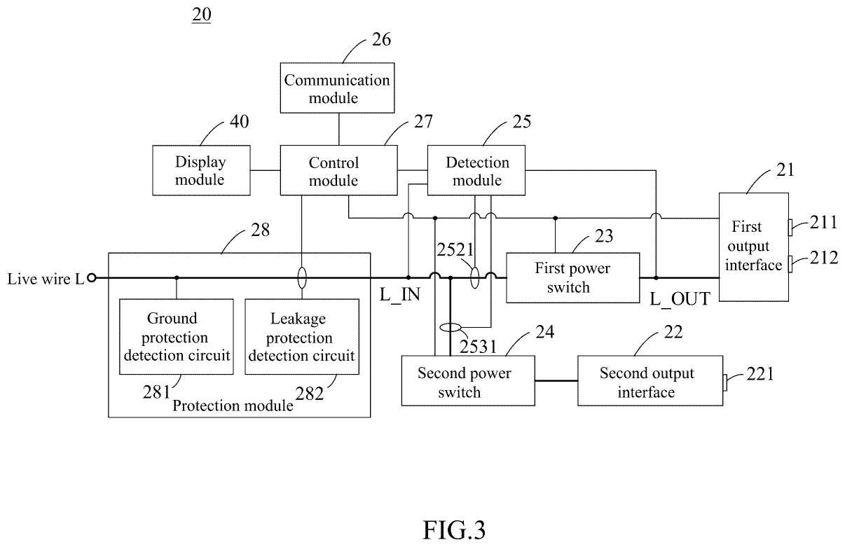

Further, referring to FIG. 3, the charging control system 20 further includes a first power switch 23, a second power switch 24, a detection module 25, a communication module 26, and a control module 27. The first power switch 23, the second power switch 24, the detection module 25, the communication module 26, and the control module 27 are all housed within the housing 10.

An input end of the first power switch 23 and an input end of the second power switch 24 are both connected to the live wire L of the external power supply, an output end of the first power switch 23 is connected to the first output interface 21, and an output end of the second power switch 24 is connected to the second output interface 22.

When the first power switch 23 is turned on, the power of the external power supply can be transmitted to the first output interface 21 through the first power switch 23 and output by the first output interface 21; when the second power switch 24 is turned on, the power of the external power supply can be transmitted to the second output interface 22 through the second power switch 24 and output by the second output interface 22. On the contrary, when the first power switch 23 is turned off, the first output interface 21 does not output power. When the second power switch 24 is turned off, the second output interface 22 does not output power.

The first power switch 23 and the second power switch 24 can both be electronically controlled switches according to actual conditions. For example, the first power switch 23 and the second power switch 24 can be relays, which can withstand high currents and high voltages and facilitate safe and stable power transmission.

The input end and the output end of the first power switch 23 and the input end of the second power switch 24 are also connected to the detection module 25 respectively. The detection module 25 can be used to detect the input and output parameters of the first power switch 23 and the second power switch 24.

In this embodiment of the present application, the detection module 25 can be used in either a single-live-wire system L1-N or a dual-live-wire system L1-L2, and has an independent reference ground MGND. When used in a single-live-wire system, the input ends of the first power switch 23 and the second power switch 24 are connected to the live wire L1, and the detection module 25 uses the neutral wire N as the reference ground MGND. When used in a dual-live-wire system, the input ends of the first power switch 23 and the second power switch 24 are connected to the live wire L1, and the detection module 25 uses the live wire L2 as a reference ground MGND.

Specifically, the detection module 25 can be used for voltage and current detection. Accordingly, the input and output parameters can include, for example, actual input voltage, actual input current, actual output voltage, and actual output current. For example, in an embodiment of the present application, the detection module 25 can detect an actual input voltage, an actual input current, an actual output voltage, and an actual output current of the first power switch 23, and detect an actual input current of the second power switch 24. Because the input end of the first power switch 23 and the input end of the second power switch 24 are both connected to the external power supply, the actual input voltage of the first power switch 23 is also the actual input voltage of the second power switch 24.

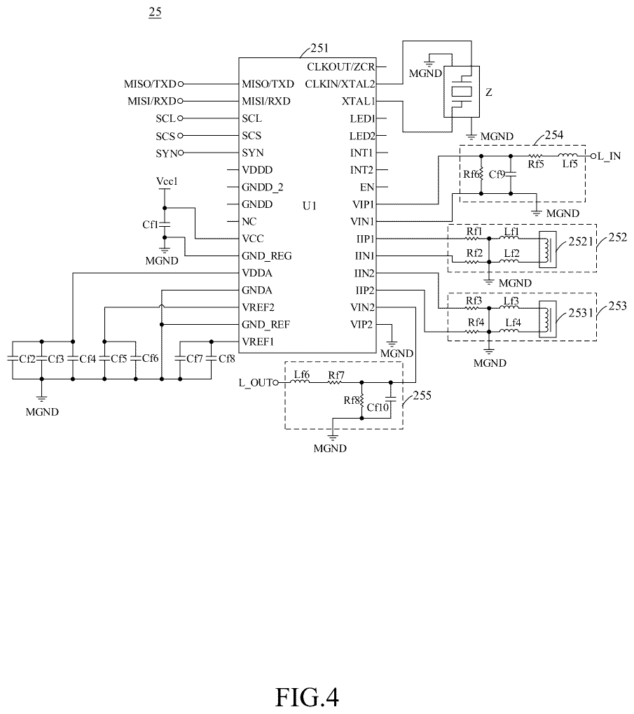

For further example, in one embodiment, as shown in FIG. 4, the detection module 25 may include a metering chip 251 (denoted as U1), a first current detection circuit 252, a second current detection circuit 253, a first voltage detection circuit 254, and a second voltage detection circuit 255. The first current detection circuit 252, the second current detection circuit 253, the first voltage detection circuit 254, and the second voltage detection circuit 255 are respectively connected to the metering chip 251.

The metering chip 251 can be any dedicated metering chip ASSP, such as the STPM3x series chips. The metering chip 251 has corresponding peripheral circuits and components, such as power supply Vcc1, crystal oscillator Z, and filter capacitors Cf1-Cf8. For the sake of brevity, these components are not described in detail here.

Both the first current detection circuit 252 and the second current detection circuit 253 can be universal current detection circuits. For example, as shown in FIG. 4, the first current detection circuit 252 includes a first current sensing element 2521 and a first RL network. The metering chip 251 is connected to the first current sensing element 2521 through the first RL network. The first current sensing element 2521 is connected to the input end of the first power switch 23. The second current detection circuit 253 includes a second current sensing element 2531 and a second RL network. The metering chip 251 is connected to the second current sensing element 2531 through the second RL network. The second current sensing element 2531 is connected to the input end of the second power switch 24.

The first current sensing element 2521 and the second current sensing element 2531 can be any current sensor. For example, as shown in FIG. 3 and FIG. 4, the first current sensing element 2521 and the second current sensing element 2531 can both be current transformers (CTs). The first current sensing element 2521 is mounted on and coupled to the input end of the first power switch 23. The second current sensing element 2531 is mounted on and coupled to the input end of the second power switch 24. The first RL network may be formed by resistors Rf1 and Rf2 and inductors Lf1 and Lf2 connected in series and in parallel, and the second RL network may be formed by resistors Rf3 and Rf4 and inductors Lf3 and Lf4 connected in series and in parallel. Both the first RL network and the second RL network are further connected to the reference ground MGND.

In this way, when the current provided by the external power supply is input to the first power switch 23, the input current of the first power switch 23 can be coupled to the first current sensing element 2521, and the metering chip 251 can further measure the input current of the first power switch 23 through the first current detection circuit 252. Similarly, when the current provided by the external power source is input to the second power switch 24, the input current of the second power switch 24 can be coupled to the second current sensing element 2531, and the metering chip 251 can then measure the input current of the second power switch 24 through the second current detection circuit 253. Both the first RL network and the second RL network can act as filters to improve the

### Accuracy of Current Detection.

The first voltage detection circuit 254 is connected to the input ends of the first power switch 23 and the second power switch 24. For the sake of convenience, this embodiment of the present application uses L_IN to represent the input end. The second voltage detection circuit 255 is connected to the output end of the first power switch 23. For the sake of convenience, this embodiment of the present application uses L_OUT to represent this output end. The metering chip 251 can detect the actual input voltages of the first power switch 23 and the second power switch 24 through the first voltage detection circuit 254, and detect the actual output voltage of the first power switch 23 through the second voltage detection circuit 255.

Both the first voltage detection circuit 254 and the second voltage detection circuit 255 can be universal voltage detection circuits. For example, as shown in FIG. 4, the first voltage detection circuit 254 includes an inductor Lf5, a resistor Rf5, a resistor Rf6, and a capacitor Cf9. The metering chip 251 is connected to one end of the inductor Lf5. The other end of the inductor Lf5, the resistor Rf5, and one end of the resistor Rf6 are connected in series. The other end of the resistor Rf6 is connected to the reference ground MGND. The capacitor Cf9 is connected in parallel with the resistor Rf6. The second voltage detection circuit 255 includes an inductor Lf6, a resistor Rf7, a resistor Rf8, and a capacitor Cf10. The metering chip 251 is connected to one end of the inductor Lf6. The other end of the inductor Lf6, the resistor Rf7, and one end of the resistor Rf8 are connected in series. The other end of the resistor Rf8 is connected to the reference ground MGND. The capacitor Cf10 is connected in parallel with the resistor Rf8.

In this way, the inductor Lf5, the resistor Rf5, and the resistor Rf6 together form a first voltage divider network, which can divide the actual input voltage of the first power switch 23. The metering chip 251 can thus obtain the actual input voltage of the first power switch 23 based on the voltage division of the first voltage detection circuit 254. The inductor Lf6, the resistor Rf7, and the resistor Rf8 together form a second voltage-divider network that divides the actual output voltage of the first power switch 23. The metering chip 251 can thus determine the actual output voltage of the first power switch 23 based on the voltage division of the second voltage detection circuit 255. The capacitors Cf9 and Cf10 act as filter capacitors, providing filtering and isolation, thereby improving voltage detection accuracy.

The control module 27 may be a microcontroller unit (MCU) or other general-purpose controller or control circuit. The communication module 26 may be, for example, a wireless communication module 26, including but not limited to a Wi-Fi module, a StarFlash module, a mobile communication (e.g., 4G/5G) module, an LTE-V communication (LTE-Vehicle-to-Everything) module, a DSRC communication (Dedicated Short-Range Communication) module, a C-V2X (Cellular Vehicle-to-Everything) module, a Bluetooth module, a ZigBee module, and the like.

The communication module 26, the first power switch 23, the second power switch 24, the first output interface 21, and the metering chip 251 of the detection module 25 are also respectively connected to the control module 27. The metering chip 251 can be connected to the control module 27 through an electrical isolation device (not shown). As shown in FIG. 4, a communication mode between the metering chip 251 and the control module 27 can be, for example, an SPI communication mode (corresponding to the MISO/TXD, MISI/RXD, and SYN pins of the metering chip 251 in FIG. 4), or a UART communication mode (corresponding to the SCL and SCS pins of the metering chip 251 in FIG. 4).

Based on this design, the control module 27 can communicate with a vehicle control unit inside the electric vehicle 200 through the communication module 26, and can also communicate with the user's electronic terminal device through the communication module 26. The user can input control instructions on the electronic terminal device and/or on the operating console of the electric vehicle 200, and the control instructions can be transmitted to the control module 27 through the communication module 26. The control instructions can be used to instruct the first output interface 21 and the second output interface 22 of the charging control system 20 whether to output power, the output parameters (such as current, voltage, power size) and output duration that the first output interface 21 needs to provide, etc., and the output parameters (such as current, voltage, power size) and output duration that the second output interface 22 needs to provide.

After receiving the control instruction, the control module 27 may be configured to control the switching states of the first power switch 23 and the second power switch 24 according to the control instruction.

For example, after the electric vehicle 200 is connected to the first output interface 21, if the electric vehicle 200 needs to be charged, the user can input a control instruction for instructing the first output interface 21 to output power, and the control module 27 then controls the first power switch 23 to turn on according to the control instruction, so that the first output interface 21 can output power to charge the electric vehicle 200. If it is necessary to pause charging of the electric vehicle 200, the user can input a control instruction to instruct the first output interface 21 to stop outputting power. The control module 27 then controls the first power switch 23 to disconnect according to the control instruction, so that the first output interface 21 has no power output and cannot charge the electric vehicle 200. If the duration of the power output by the first output interface 21 reaches the duration indicated by the control instruction, the control module 27 may automatically control the first power switch 23 to be disconnected.

Similarly, after the electrical device 300 is connected to the second output interface 22, if the electrical device 300 needs to be charged, the user can input a control instruction for instructing the second output interface 22 to output power, and the control module 27 then controls the second power switch 24 to turn on according to the control instruction, so that the second output interface 22 can output power to charge the electrical device 300. If it is necessary to suspend charging of the electric device 300, the user can input a control instruction to instruct the second output interface 22 to stop outputting power. The control module 27 then controls the second power switch 24 to be turned off according to the control instruction, so that the second output interface 22 has no power output and cannot charge the electric device 300. If the duration of the second output interface 22 outputting power reaches the duration indicated by the control instruction, the control module 27 can also automatically control the second power switch 24 to be turned off.

During the charging process, the control module 27 can also be used to receive the detection data measured in real time by the detection module 25, and calculate the power transmitted by the first power switch 23 based on the actual input voltage and actual input current of the first power switch 23 measured by the detection module 25, and calculate the power transmitted by the second power switch 24 based on the actual input voltage and actual input current of the second power switch 24 measured by the detection module 25. The sum of the power transmitted by the first power switch 23 and the power transmitted by the second power switch 24 is equal to the input power provided by the external power supply to the charging control system 20.

Generally speaking, the actual output power of the first output interface 21 is equal to or substantially equal to the power transmitted by the first power switch 23, and the actual output power does not exceed the available output power of the first output interface 21. The actual output power of the second output interface 22 is equal to or substantially equal to the power transmitted by the second power switch 24, and the actual output power does not exceed the available output power of the second output interface 22. However, since the electric vehicle 200 can regulate the charging current, the actual output current of the first output interface 21 may change, for example, increase to a value exceeding the originally set available output current value of the first output interface 21, while the output voltage of the first output interface 21 remains unchanged. This will cause the output power of the first output interface 21 to increase, so that the sum of the output power of the first output interface 21 and the output power of the second output interface 22 exceeds the input power, resulting in an output overload of the charging control system 20. This may cause the charging control system 20 to heat abnormally, or even cause damage, shorten its life, and other safety issues.

Therefore, to ensure charging safety, the control module 27 can also be used to calculate the available output current value of the first output interface 21 based on the detection data, and control the switching status of the first power switch 23 and the second power switch 24 accordingly, and/or, communicate with the electric vehicle 200 through the first output interface 21, and the electric vehicle 200 implements the current regulation of the first output interface 21. In this way, the total output power of the second output interface 22 and the first output interface 21 does not exceed the input power provided by the external power supply, thereby avoiding safety risks caused by output overload of the charging control system 20.

For example, when the first output interface 21 is connected to the electric vehicle 200 and the second output interface 22 is connected to the electric device 300, if the total output power of the second output interface 22 and the first output interface 21 exceeds the input power provided by the external power supply, and both the electric vehicle 200 and the electrical device 300 need to be charged immediately, the control module 27 can control the first power switch 23 and the second power switch 24 to be turned on, so that the first power switch 23, the first output interface 21 and the electric vehicle 200 are connected to form a power supply path, and the first output interface 21 can output power to the electric vehicle 200; the second power switch 24, the second output interface 22 and the electrical device 300 are connected to form another power supply path, and the second output interface 22 can output power to the electrical device 300. The control module 27 can also output the latest available output current information generated by the control module 27 to the electric vehicle 200 through the signal terminal 212 of the first output interface 21. The available output current information is used to indicate the latest available output current value of the first output interface 21, so that the electric vehicle 200 can regulate the actual charging current of the electric vehicle 200 according to the latest available output current value, for example, lowering the actual charging current of the electric vehicle 200, thereby lowering the actual output current of the first output interface 21, thereby making the actual charging current of the electric vehicle 200 and the actual output current of the first output interface 21 both exceed the available output current value, and the actual charging speed of the electric vehicle 200 is slowed down. In this way, the sum of the output power of the first output interface 21 and the output power of the second output interface 22 can be prevented from exceeding the input power.

For another example, when the first output interface 21 is connected to the electric vehicle 200 and the second output interface 22 is connected to the electrical device 300, if the total output power of the second output interface 22 and the first output interface 21 exceeds the input power provided by the external power supply, and the electric vehicle 200 requires a larger charging current for fast charging, the control module 27 can control the first power switch 23 to be turned on and the second power switch 24 to be turned off to prioritize the charging of the electric vehicle 200. The control module 27 may also communicate with the electric vehicle 200 through the signal terminal 212 of the first output interface 21 to adjust the actual charging current of the electric vehicle 200, thereby adjusting the actual charging speed of the electric vehicle 200.

For another example, when the first output interface 21 is connected to the electric vehicle 200 and the second output interface 22 is connected to the electrical device 300, if the total output power of the second output interface 22 and the first output interface 21 exceeds the input power provided by the external power supply, and the electrical device 300 requires a shorter charging time, the control module 27 can control the second power switch 24 to be turned on and the first power switch 23 to be turned off, so as to give priority to charging the electrical device 300.

In addition, the control module 27 can also transmit the charging information of the first output interface 21 and the second output interface 22 to the electric vehicle 200 and/or the electronic terminal device through the communication module 26. The charging information may include, for example, the output power that the first output interface 21 and the second output interface 22 can provide, the power actually output by the first output interface 21 and the second output interface 22 and the duration during the charging process, billing information, etc.

In some embodiments, to improve operational safety and charging safety, please continue to refer to FIG. 3, the charging control system 20 may further include a protection module 28. The protection module 28 is connected between the input ends of the first power switch 23 and the second power switch 24 and the external power supply. The protection module 28 is also connected to the control module 27. The control module 27 can be used to detect abnormalities in the charging control system 20 through the protection module 28 and control the first power switch 23 and the second power switch 24 to be disconnected when an abnormality occurs in the charging control system 20, so as to protect the charging control system 20 and the electric vehicle 200 and the electrical device 300 connected thereto.

The abnormality may include, for example, the ground wire is not connected to the neutral wire, the leakage current of the charging control system 20 exceeds a preset current threshold, or the charging control system 20 is overvoltage, undervoltage, overcurrent, or overtemperature.

For example, as shown in FIG. 3, in one embodiment, the protection module 28 includes a ground protection detection circuit 281 and a leakage protection detection circuit 282. The ground protection detection circuit 281 is used to detect whether the ground line is connected to the neutral line, and the leakage protection detection circuit 282 is used to detect whether the leakage current of the charging control system 20 exceeds the preset current threshold. The ground GND of the ground protection detection circuit 281 and the leakage protection detection circuit 282 are different from the ground MGND, and the GND is connected to the ground line.

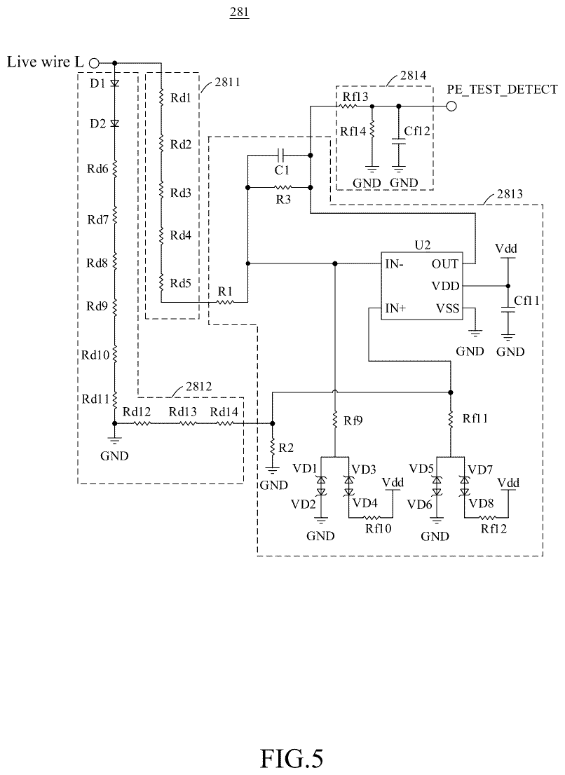

As shown in FIG. 5, the ground fault detection circuit 281 includes a first voltage divider circuit 2811, a second voltage divider circuit 2812, an operational amplifier circuit 2813, and a first output filter circuit 2814. A first input end of the operational amplifier circuit 2813 is connected to the live wire L through the first voltage divider circuit 2811, a second input end of the operational amplifier circuit 2813 is connected to the live wire L and ground through the second voltage divider circuit 2812, and an output end of the operational amplifier circuit 2813 is connected to the control module 27 through the first output filter circuit 2814.

For example, the operational amplifier circuit 2813 mainly includes an operational amplifier chip U2, a first input resistor R1, a second input resistor R2, a feedback resistor R3, a feedback capacitor C1, a first voltage stabilization circuit, and a second voltage stabilization circuit. The operational amplifier chip U2 can be selected according to actual conditions, for example, the NCS21911 series operational amplifier can be used. The operational amplifier chip U2 has corresponding peripheral circuits such as a power supply Vdd, a filter capacitor Cf11, etc. For the sake of brevity, they will not be described in detail here. The first output filter circuit 2814 includes filter resistors Rf13 and Rf14 and a filter capacitor Cf12.

The first voltage divider is electrically connected between the live wire L and the first input resistor R1, and can divide the voltage provided by the live wire L into the input voltage Vin1 of the first input resistor R1. The first voltage divider circuit 2811 is composed of multiple voltage divider resistors, for example, voltage divider resistors Rd1-Rd5 connected in series. The second voltage divider is electrically connected between the live wire L and the second input resistor R2, and can divide the voltage provided by the live wire L into the input voltage Vin2 of the second input resistor R2. The second voltage divider circuit 2812 is composed of multiple voltage divider resistors and multiple diodes, such as diodes D1 and D2 and voltage divider resistors Rd6 through Rd14. Diodes D1 and D2 and voltage divider resistors Rd6 through Rd14 are connected in series and then connected to second input resistor R2. The connection point between voltage divider resistors Rd11 and Rd12 is also grounded. A first input resistor R1 is also connected to the inverting input end IN-of operational amplifier chip U2. A second input resistor R2 is also connected to the non-inverting input end IN+ of the operational amplifier chip U2 and to ground. A feedback resistor R3 is connected between the inverting input end IN− and the output end of the operational amplifier chip U2. A feedback capacitor C1 is connected in parallel with the feedback resistor R3. The output of the operational amplifier chip U2 is further connected to the control module 27 via a filter resistor Rf13. The filter resistor Rf13 is further connected to ground via a parallel filter resistor Rf14 and a filter capacitor Cf12. It should be understood that the model parameters of each resistor, capacitor, and diode component can be selected according to actual conditions and are not limited here.

Thus, the operational amplifier circuit 2813 constitutes a differential operational amplifier circuit 2813. The operational amplifier circuit 2813 can be used to amplify the voltage difference Vin1-Vin2 between the first input end and the second output end to generate a ground detection signal PE_TEST_DETECT. The ground detection signal PE_TEST_DETECT is transmitted to the control module 27 through the first output filter circuit 2814. The amplification process is beneficial to improving the detection accuracy. The first output filter circuit 2814 can perform a filtering circuit on the ground detection signal PE_TEST_DETECT to improve the detection accuracy.

When the neutral line of the external power source is connected to the ground line, that is, when the charging control system 20 is properly grounded, the ground detection signal is less than the preset voltage threshold. In other words, a ground detection signal less than the preset voltage threshold can indicate that the neutral line of the external power source is connected to the ground line. When the neutral line of the external power source is not connected to the ground line, that is, when the charging control system 20 is abnormally grounded, the ground detection signal is greater than or equal to the preset voltage threshold. In other words, a ground detection signal greater than or equal to the preset voltage threshold indicates that the neutral line of the external power source is not connected to the ground line.

If the ground wire is not connected to the neutral wire, there is a risk of electric shock and malfunction in the charging control system 20. Therefore, in this case, the control module 27 can control the first power switch 23 and the second power switch 24 to be turned off in response to the ground detection signal that is greater than or equal to the preset voltage threshold.

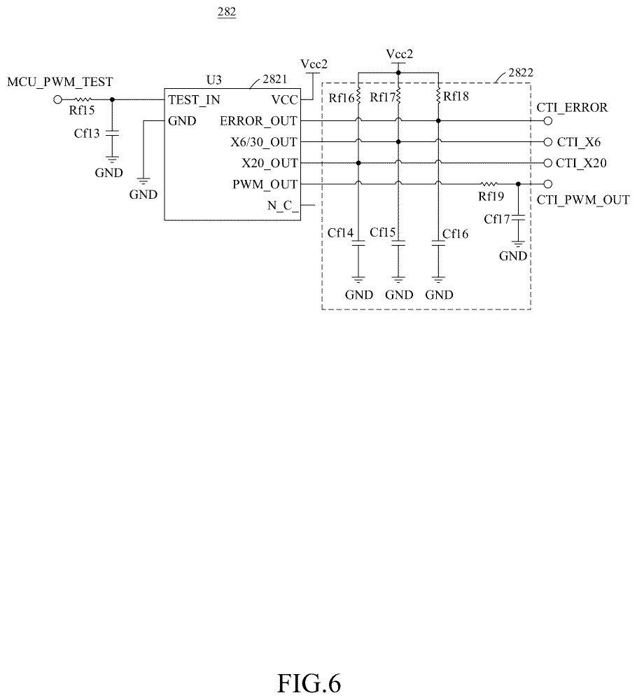

As shown in FIG. 6, the leakage protection detection circuit 282 includes a closed-loop current sensor 2821 (corresponding to U3 in FIG. 6) and a second output filter circuit 2822. The closed-loop current sensor 2821 features high precision, fast response, and anti-interference capabilities. For example, the closed-loop current sensor 2821 can be a T60404 series closed-loop current sensor 2821. Other closed-loop current sensors 2821 can also be used depending on the specific situation. The closed-loop current sensor 2821 has corresponding peripheral circuits and peripheral components, such as the power supply Vcc2, which are not described in detail here for brevity. The second output filter circuit 2822 includes filter resistors Rf16-Rf19 and filter capacitors Cf14-Cf17.

The closed-loop current sensor 2821 has a magnetic core and a current sensing element, such as a Hall element, so the closed-loop current sensor 2821 can be mounted outside the live wire L and coupled to the live wire L to sense current. A ground end GND of the closed-loop current sensor 2821 is grounded. A test end of the closed-loop current sensor 2821 (i.e., the TST_IN pin of U3) is also connected to control module 27. The TST_IN pin can be grounded via the filter capacitor Cf13 and connected to the control module 27 via the filter resistor Rf15. An output end ERROR_OUT, an output end X6/30_OUT, an output end X20_OUT, and an output end PWM_OUT of the closed-loop current sensor 2821 are also connected to the control module 27. The output end ERROR_OUT is connected to Vcc2 and ground through a series filter resistor Rf16 and a filter capacitor Cf14. The output end X6/30_OUT is connected to Vcc2 and ground through a series filter resistor Rf17 and a filter capacitor Cf15. The output end X20_OUT is connected to Vcc2 and ground through a series filter resistor Rf18 and a filter capacitor Cf16. The output end PWM_OUT is grounded through a series filter resistor Rf19 and a filter capacitor Cf17.

In this way, the control module 27 can control the closed-loop current sensor 2821 to perform regular self-test. When the closed-loop current sensor 2821 fails to self-test, it indicates that there is an abnormality in the closed-loop current sensor 2821. Therefore, the output end ERROR_OUT outputs a prompt signal to the control module 27. The prompt signal is used to indicate that there is an abnormality in the closed-loop current sensor 2821. To ensure charging safety, the control module 27 can control the first power switch 23 and the second power switch 24 to be turned off in response to the prompt signal.

When the closed-loop current sensor 2821 successfully performs self-test, it indicates that the closed-loop current sensor 2821 is normal. Therefore, the closed-loop current sensor 2821 can be used to detect leakage current of the live wire and the ground wire and generate a corresponding leakage current detection signal, which is transmitted to the control module 27 through the second output filter circuit 2822.

The corresponding leakage current detection signal outputted by the output end PWM_OUT is used to indicate the specific magnitude of the leakage current in the live wire L and the ground wire PE. The output end X6/30_OUT and the output end X20_OUT each correspond to different current thresholds. When the leakage current exceeds the current threshold corresponding to the output end X6/30_OUT, the output end X6/30_OUT outputs a corresponding leakage current detection signal to the control module 27, indicating that the leakage current of the live wire L and the ground wire PE exceeds the current threshold corresponding to the output end X6/30_OUT. When the leakage current exceeds the current threshold corresponding to the output end X20_OUT, the output end X20_OUT outputs a corresponding leakage current detection signal to the control module 27, and the output end X20_OUT outputs a corresponding leakage current detection signal to indicate that the leakage current of the live wire L and the ground wire PE exceeds the current threshold corresponding to the output end X20_OUT.

If the leakage current exceeds the safety threshold specified by relevant standards and regulations (such as CNS, IEC, or UL standards), the charging control system 20 may pose a risk of electric shock and malfunction. Therefore, when the leakage current exceeds the preset safety threshold, the control module 27 can control the first power switch 23 and the second power switch 24 to be disconnected.

For another example, the protection module 28 can be provided with a universal overvoltage protection detection circuit to detect whether the input voltage and output voltage of the first power switch 23 exceed a preset overvoltage threshold, can be provided with a universal undervoltage protection detection circuit to detect whether the input voltage and output voltage of the first power switch 23 are lower than a preset undervoltage threshold, and can be provided with a universal overcurrent protection detection circuit to detect whether the actual input current and actual output current of the first power switch 23 exceed a preset overcurrent threshold.

When the input voltage of the first power switch 23 exceeds the overvoltage threshold, or the output voltage of the first power switch 23 exceeds the overvoltage threshold, the overvoltage protection detection circuit generates a corresponding overvoltage detection signal to the control module 27, and the control module 27 then controls the first power switch 23 to be disconnected, thereby achieving overvoltage protection.

When the input voltage of the first power switch 23 is lower than the preset undervoltage threshold, or the output voltage of the first power switch 23 is lower than the preset undervoltage threshold, the undervoltage protection detection circuit generates a corresponding undervoltage detection signal to the control module 27, and the control module 27 then controls the first power switch 23 to be disconnected, thereby achieving undervoltage protection.

When the actual input current of the first power switch 23 or the second power switch 24 is lower than the preset overcurrent threshold, or the actual output current of the first power switch 23 or the second power switch 24 is lower than the preset overcurrent threshold, the overcurrent protection detection circuit generates a corresponding overcurrent detection signal to the control module 27, and the control module 27 then controls the first power switch 23 to be disconnected, thereby achieving overcurrent protection.

The overvoltage, undervoltage and overcurrent detection of the second power switch 24 are similar and will not be described in detail here.

For another example, the protection module 28 can use a universal temperature sensor to detect whether the component temperature of the charging control system 20 or the ambient temperature thereof exceeds a preset over-temperature threshold. When the detected temperature of the temperature sensor exceeds the preset over-temperature threshold, the over-temperature protection detection circuit generates a corresponding over-temperature detection signal to the control module 27, and the control module 27 then controls the first power switch 23 to disconnect, thereby achieving over-temperature protection.

Referring again to FIGS. 2 and 3, the charging pile 100 of the embodiment of the present application may further include a display module 40. The display module 40 may be any component or circuit module capable of implementing a visual display. For example, the display module 40 of the present embodiment includes a display screen 41, a first indicator light 42, and a second indicator light 43. The display screen 41, the first indicator light 42, and the second indicator light 43 are exposed on the outer surface of the housing 10. The display screen 41, the first indicator light 42, and the second indicator light 43 are also connected to the control module 27. The control module 27 is configured to output charging information from the first output interface 21 to the display screen 41 and the first indicator light 42. The control module 27 is configured to output charging information from the second output interface 22 to the display screen 41 and the second indicator light 43. The display screen 41, the first indicator light 42, and the second indicator light 43 can visually display or prompt the corresponding charging information.

For example, when the first output interface 21 is connected to the electric vehicle 200 and charging the electric vehicle 200, the display screen 41 may display a corresponding display page, and the first indicator light 42 may be in a state of lighting or flashing. When the first output interface 21 is not connected to the electric vehicle 200, the display screen 41 may display a corresponding display page, and the first indicator light 42 may be in an off state. Similarly, when the second output interface 22 is connected to the electrical device 300 and charging the electrical device 300, the display screen 41 may display the corresponding display page, and the second indicator light 43 may be in a state of lighting or flashing. When the second output interface 22 is not connected to the electrical device 300, the display screen 41 may display the corresponding display page, and the second indicator light 43 may be in an off state. Similarly, when the second output interface 22 is connected to the electrical device 300 and charging the electrical device 300, the display screen 41 may display the corresponding display page, and the second indicator light 43 may be in a state of lighting or flashing. When the second output interface 22 is not connected to the electrical device 300, the display screen 41 may display the corresponding display page, and the second indicator light 43 may be in an off state.

The embodiment of the present application may further include the first output interface 21 to charge two, three, or more electric vehicles 200. The embodiment of the present application may further include the second output interface 22 to power two, three, or more electrical devices 300. Each first output interface 21 corresponds to the first power switch 23 and is used to connect to a corresponding electric vehicle 200 and provide power to the connected electric vehicles 200. Each second output interface 22 corresponds to the second power switch 24 and is used to connect to the corresponding electrical device 300 and power the connected electrical device 300. It should be understood that the total output power of all second output interfaces 22 and all first output interfaces 21 does not exceed the input power provided by the external power supply.

It should be noted that any steps and any technical features of the above-mentioned embodiments of the present application can be freely and arbitrarily combined, and the combined technical solutions are also within the scope of the present application.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A charging control system applied to a charging pile, the charging pile connected to an external power supply, the charging control system comprising: a first power switch, a second power switch, a first output interface, a second output interface, a detection module, and a control module; wherein
an input end of the first power switch and an input end of the second power switch are both connected to the external power supply, an output end of the first power switch is connected to the first output interface, and an output end of the second power switch is connected to the second output interface; the first output interface is configured to connect to an electric vehicle, the second output interface is configured to connect to an electrical device of a different type from the electric vehicle;
the input end and the output end of the first power switch and the input end of the second power switch are respectively connected to the detection module; the detection module, the first power switch, the second power switch and the first output interface are also respectively connected to the control module; the detection module is configured to detect input and output parameters of the first power switch and the second power switch and transmit the input and output parameters to the control module, control switching states of the first power switch and the second power switch, and/or communicate with the electric vehicle through the first output interface;
the first output interface outputs power when the first power switch is closed, and the second output interface outputs power when the second power switch is closed, a total output power of the second output interface and the first output interface does not exceed an input power provided by the external power supply.

2. The charging control system of claim 1, wherein the first output interface comprises a power terminal and a signal terminal, the first output interface is configured to output power to the electric vehicle through the power terminal, and is configured to output available output current information generated by the control module to the electric vehicle through the signal terminal;
the available output current information is configured to indicate an available output current value of the first output interface, and an actual output current of the first output interface and an actual charging current of the electric vehicle do not exceed the available output current value of the first output interface.

3. The charging control system of claim 1, wherein the detection module comprises a first current detection circuit, a second current detection circuit, a first voltage detection circuit, and a second voltage detection circuit;
the first current detection circuit comprises a first current sensing element, the first current detection circuit is connected to the input end of the first power switch via the first current sensing element; the second current detection circuit comprises a second current sensing element, the second current detection circuit is connected to the input end of the second power switch via the second current sensing element;
the first voltage detection circuit is connected to the input end of the first power switch and the input end of the second power switch, the second voltage detection circuit is connected to the output end of the first power switch.

4. The charging control system of claim 3, wherein the detection module further comprises a metering chip, the first current detection circuit, the second current detection circuit, the first voltage detection circuit, and the second voltage detection circuit are respectively connected to the metering chip;
the metering chip is configured to detect an actual output current of the first output interface through the first current detection circuit, detect an actual output current of the second output interface through the first current detection circuit, detect an actual input voltage of the first power switch and the second power switch through the first voltage detection circuit, and detect an actual output voltage of the first power switch through the second voltage detection circuit.

5. The charging control system of claim 1, further comprising a protection module, wherein the protection module is connected between the input end of the first power switch and the input end of the second power switch and the external power supply, the protection module is further connected to the control module, the control module is configured to detect an abnormality in the charging control system through the protection module and control the first power switch and the second power switch to be disconnected when an abnormality occurs in the charging control system;
the abnormality comprises that a ground wire is not connected to a neutral wire, a leakage current of the charging control system exceeds a preset current threshold, and the charging control system is at least one of overvoltage, undervoltage, overcurrent, and overtemperature.

6. The charging control system of claim 5, wherein the protection module comprises at least one of a ground protection detection circuit and a leakage protection detection circuit;
the ground protection detection circuit comprises a first voltage divider circuit, a second voltage divider circuit, an operational amplifier circuit and a first output filter circuit, a first input end of the operational amplifier circuit is connected to a live wire of the external power supply through the first voltage divider circuit, a second input end of the operational amplifier circuit is connected to the live wire of the external power supply and the ground through the second voltage divider circuit, the output end of the operational amplifier circuit is connected to the control module through the first output filter circuit, the operational amplifier circuit is configured to amplify a voltage difference between the first input end and the second output end to generate a ground detection signal to the control module;
the ground detection signal having a voltage less than a preset voltage threshold is configured to indicate that the neutral line of the external power supply is connected to the ground line, the ground detection signal having a voltage greater than or equal to the preset voltage threshold is configured to indicate that the neutral line of the external power supply is not connected to the ground line.

7. The charging control system of claim 6, wherein the leakage protection detection circuit comprises a closed-loop current sensor and a second output filter circuit, the closed-loop current sensor is arranged outside the live wire of the external power supply and coupled to the live wire of the external power supply, a ground end of the closed-loop current sensor is grounded, an output end of the closed-loop current sensor is connected to the control module, the closed-loop current sensor is configured to detect a leakage current of the live wire and the ground wire of the external power supply and generate a corresponding leakage current detection signal to the control module;
the leakage current detection signal is configured to indicate a magnitude of the leakage current of the live wire and the ground wire of the external power supply.

8. The charging control system of claim 1, further comprising a communication module, wherein the communication module is connected to the control module, the control module is configured to communicate with at least one of the electric vehicle and an electronic terminal device through the communication module to receive control instructions from at least one of the electric vehicle and the electronic terminal device, and/or transmit charging information of the first output interface and the second output interface to at least one of the electric vehicle and the electronic terminal device.

9. A charging pile comprising charging control system, the charging pile connected to an external power supply, the charging control system comprising: a first power switch, a second power switch, a first output interface, a second output interface, a detection module, and a control module; wherein
an input end of the first power switch and an input end of the second power switch are both connected to the external power supply, an output end of the first power switch is connected to the first output interface, and an output end of the second power switch is connected to the second output interface; the first output interface is configured to connect to an electric vehicle, the second output interface is configured to connect to an electrical device of a different type from the electric vehicle;
the input end and the output end of the first power switch and the input end of the second power switch are respectively connected to the detection module; the detection module, the first power switch, the second power switch and the first output interface are also respectively connected to the control module; the detection module is configured to detect input and output parameters of the first power switch and the second power switch and transmit the input and output parameters to the control module, control switching states of the first power switch and the second power switch, and/or communicate with the electric vehicle through the first output interface;
the first output interface outputs power when the first power switch is closed, and the second output interface outputs power when the second power switch is closed, a total output power of the second output interface and the first output interface does not exceed an input power provided by the external power supply;
the charging pile is configured to supply power to at least one of the electric vehicle and the electrical device through the charging control system.

10. The charging pile of claim 9, wherein the first output interface comprises a power terminal and a signal terminal, the first output interface is configured to output power to the electric vehicle through the power terminal, and is configured to output available output current information generated by the control module to the electric vehicle through the signal terminal;
the available output current information is configured to indicate an available output current value of the first output interface, and an actual output current of the first output interface and an actual charging current of the electric vehicle do not exceed the available output current value of the first output interface.

11. The charging pile of claim 9, wherein the detection module comprises a first current detection circuit, a second current detection circuit, a first voltage detection circuit, and a second voltage detection circuit;
the first current detection circuit comprises a first current sensing element, the first current detection circuit is connected to the input end of the first power switch via the first current sensing element; the second current detection circuit comprises a second current sensing element, the second current detection circuit is connected to the input end of the second power switch via the second current sensing element;
the first voltage detection circuit is connected to the input end of the first power switch and the input end of the second power switch, the second voltage detection circuit is connected to the output end of the first power switch.

12. The charging pile of claim 11, wherein the detection module further comprises a metering chip, the first current detection circuit, the second current detection circuit, the first voltage detection circuit, and the second voltage detection circuit are respectively connected to the metering chip;
the metering chip is configured to detect an actual output current of the first output interface through the first current detection circuit, detect an actual output current of the second output interface through the first current detection circuit, detect an actual input voltage of the first power switch and the second power switch through the first voltage detection circuit, and detect an actual output voltage of the first power switch through the second voltage detection circuit.

13. The charging pile of claim 9, wherein the charging control system further comprises a protection module, the protection module is connected between the input end of the first power switch and the input end of the second power switch and the external power supply, the protection module is further connected to the control module, the control module is configured to detect an abnormality in the charging control system through the protection module and control the first power switch and the second power switch to be disconnected when an abnormality occurs in the charging control system;
the abnormality comprises that a ground wire is not connected to a neutral wire, a leakage current of the charging control system exceeds a preset current threshold, and the charging control system is at least one of overvoltage, undervoltage, overcurrent, and overtemperature.

14. The charging pile of claim 13, wherein the protection module comprises at least one of a ground protection detection circuit and a leakage protection detection circuit;
the ground protection detection circuit comprises a first voltage divider circuit, a second voltage divider circuit, an operational amplifier circuit and a first output filter circuit, a first input end of the operational amplifier circuit is connected to a live wire of the external power supply through the first voltage divider circuit, a second input end of the operational amplifier circuit is connected to the live wire of the external power supply and the ground through the second voltage divider circuit, the output end of the operational amplifier circuit is connected to the control module through the first output filter circuit, the operational amplifier circuit is configured to amplify a voltage difference between the first input end and the second output end to generate a ground detection signal to the control module;
the ground detection signal having a voltage less than a preset voltage threshold is configured to indicate that the neutral line of the external power supply is connected to the ground line, the ground detection signal having a voltage greater than or equal to the preset voltage threshold is configured to indicate that the neutral line of the external power supply is not connected to the ground line.

15. The charging pile of claim 14, wherein the leakage protection detection circuit comprises a closed-loop current sensor and a second output filter circuit, the closed-loop current sensor is arranged outside the live wire of the external power supply and coupled to the live wire of the external power supply, a ground end of the closed-loop current sensor is grounded, an output end of the closed-loop current sensor is connected to the control module, the closed-loop current sensor is configured to detect a leakage current of the live wire and the ground wire of the external power supply and generate a corresponding leakage current detection signal to the control module;
the leakage current detection signal is configured to indicate a magnitude of the leakage current of the live wire and the ground wire of the external power supply.

16. The charging pile of claim 9, wherein the charging control system further comprises a communication module, the communication module is connected to the control module, the control module is configured to communicate with at least one of the electric vehicle and an electronic terminal device through the communication module to receive control instructions from at least one of the electric vehicle and the electronic terminal device, and/or transmit charging information of the first output interface and the second output interface to at least one of the electric vehicle and the electronic terminal device.

17. The charging pile of claim 9, wherein the first output interface is a charging plug; the second output interface is a socket compatible with the electrical device, the electrical device comprises an electronic terminal device.

18. The charging pile of claim 9, wherein the charging pile further comprises a housing, the first power switch, the second power switch, the communication module, the detection module, and the control module are accommodated in the housing, the first output interface and the second output interface are both exposed on an outer surface of the housing.

19. The charging pile of claim 18, further comprising a display module, wherein the display module is exposed on the outer surface of the housing and is connected to the control module, the control module is configured to output charging information of at least one of the first output interface and the second output interface to the display module for visual display.
